(19) United States
(12) Patent Application Publication
(10) Pub. No.: US 2020/0070822 A1
(43) Pub. Date: Mar. 5, 2020

(54) SYSTEMS AND METHODS FOR PREDICTING OBJECT BEHAVIOR

(71) Applicant: GM GLOBAL TECHNOLOGY OPERATIONS LLC, Detroit, MI (US)

(72) Inventors: Kenji Yamada, Los Angeles, CA (US); Rajan Bhattacharyya, Sherman Oaks, CA (US)

(73) Assignee: GM GLOBAL TECHNOLOGY OPERATIONS LLC, Detroit, MI (US)

(21) Appl. No.: 16/121,485

(22) Filed: Sep. 4, 2018

(51) Int. Cl. B60W 30/095; G06F 17/50; G05D 1/00

(52) U.S. Cl. CPC B60W 30/0956; G06F 17/5009; B60W 10/20; G06F 2217/16; G05D 1/0088

(57) ABSTRACT

Systems and method are provided for controlling a vehicle. In one embodiment, a method includes: receiving sensor data sensed from an environment associated with the vehicle; processing, by a processor, the sensor data to determine a plurality of objects within the environment of the vehicle; processing, by the processor, the sensor data to determine feature data associated with each of the plurality of objects, wherein the feature data includes current data of each object, history data of each object, and interaction data between each object and at least two other objects; processing, by the processor, the feature data associated with a first object of the plurality of objects with a model to determine a future position of the first object; and controlling, by the processor, the vehicle based on the future position.

### TECHNICAL FIELD

The present disclosure generally relates to autonomous vehicles, and more particularly relates to systems and methods for predicting behavior of various objects within an environment of an autonomous vehicle.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle and perform traffic prediction.

While recent years have seen significant advancements in behavior prediction systems, such systems might still be improved in a number of respects. For example, an autonomous vehicle will typically encounter, during normal operation, a large number of vehicles and other objects, each of which might exhibit its own, hard-to-predict behavior. That is, even when an autonomous vehicle has an accurate semantic understanding of the roadway and has correctly detected and classified objects in its vicinity, the vehicle may yet be unable to accurately predict the trajectory and/or paths of certain objects in a variety of contexts.

Accordingly, it is desirable to provide systems and methods that are capable of predicting the behavior of various objects encountered by an autonomous vehicle. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a vehicle. In one embodiment, a method includes: receiving sensor data sensed from an environment associated with the vehicle; processing, by a processor, the sensor data to determine a plurality of objects within the environment of the vehicle; processing, by the processor, the sensor data to determine feature data associated with each of the plurality of objects, wherein the feature data includes current data of each object, history data of each object, and interaction data between each object and at least two other objects; processing, by the processor, the feature data associated with a first object of the plurality of objects with a model to determine a future position of the first object; and controlling, by the processor, the vehicle based on the future position.

In various embodiments, the current data includes speed data, heading data, object type data, and road type data.

In various embodiments, the history data includes a change in speed data, a change in heading data, and road type data.

In various embodiments, the interaction data includes current data of each object of the at least two other objects, and history data of each object of the at least two other objects. In various embodiments, the current data of the interaction data includes angle data, distance data, heading data, object type data, and road type data. In various embodiments, the history data of the interaction data includes angle data, distance data, and road type data.

In various embodiments, the model is a regression model. In various embodiments, the regression model is a tree-based regression model. In various embodiments, the model is selected from a plurality of models based on a number of features included in the feature data.

In one embodiment, a system includes: a data storage device that stores at least one model; and a processor configured to receive sensor data sensed from an environment associated with the vehicle, process the sensor data to determine a plurality of objects within the environment of the vehicle, process the sensor data to determine feature data associated with each of the plurality of objects, wherein the feature data includes current data of each object, history data of each object, and interaction data between each object and at least two other objects, process the feature data associated with a first object of the plurality of objects with a model to determine a future position of the first object, and control the vehicle based on the future position.

In various embodiments, the current data includes speed data, heading data, object type data, and road type data.

In various embodiments, the history data includes a change in speed data, a change in heading data, and road type data.

In various embodiments, the interaction data includes current data of each object of the at least two other objects, and history data of each object of the at least two other objects. In various embodiments, the current data includes angle data, distance data, heading data, object type data, and road type data. In various embodiments, the history data includes angle data, distance data, and road type data.

In various embodiments, the model is a regression model. In various embodiments, the regression model is a tree-based regression model. In various embodiments, the processor is further configured to select the model from a plurality of models based on a number of features included in the feature data.

In one embodiment, an autonomous vehicle includes: a sensor system configured to observe an environment associated with the autonomous vehicle; a control module configured to, by a processor, receive sensor data sensed from the environment associated with the autonomous vehicle, process the sensor data to determine a plurality of objects within the environment of the autonomous vehicle, process the sensor data to determine feature data associated with each of the plurality of objects, process the feature data associated with a first object of the plurality of objects with a model to determine a future position of the first object, and control the autonomous vehicle based on the future position.

The feature data includes current data of each object, history data of each object, and interaction data between each object and at least two other objects. The current data includes speed data, heading data, object type data, and road type data. The history data includes a change in speed data, a change in heading data, and road type data. The interaction data includes current data of each object of the at least two other objects, and history data of each object of the at least two other objects.

In various embodiments, the current data of the interaction data includes angle data, distance data, heading data, object type data, and road type data. In various embodiments, the history data of the interaction data includes angle data, distance data, and road type data.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having an object behavior prediction system, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a dataflow diagram illustrating an object behavior prediction module, in accordance with various embodiments;

FIG. 5 is an illustrations of a tree-based regression model that may be used by the object behavior prediction system, in accordance with various embodiments; and

FIG. 6 is a flowchart illustrating a control method for controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein are merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

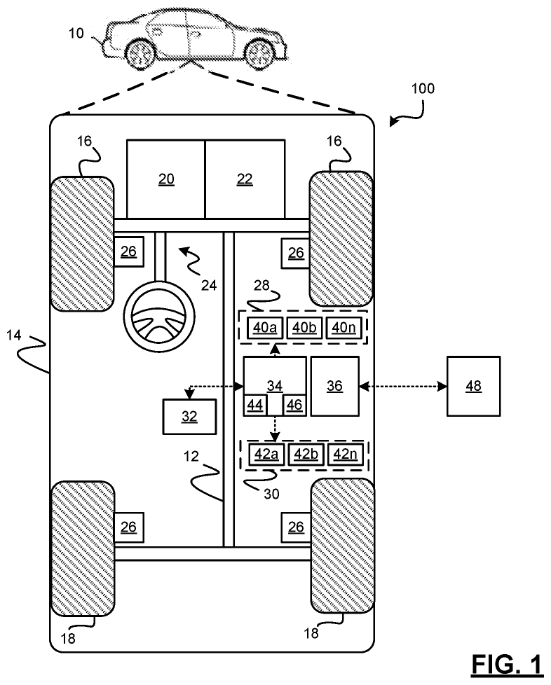

With reference to FIG. 1, an object behavior prediction system shown generally as 100 is associated with a vehicle 10 in accordance with various embodiments. In general, the object behavior prediction system (or simply “system”) 100 is configured to predict the future path (or “trajectory”) of objects based on observations related to those objects. In various embodiments, the object behavior prediction system 100 observes current features of the object, historical features of the object, and interaction features with other objects the environment using a regression model. As used herein the term “objects” refers to other vehicles, bicycles, objects, pedestrians, or other moving elements within an environment of the vehicle 10.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the object behavior prediction system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n might include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

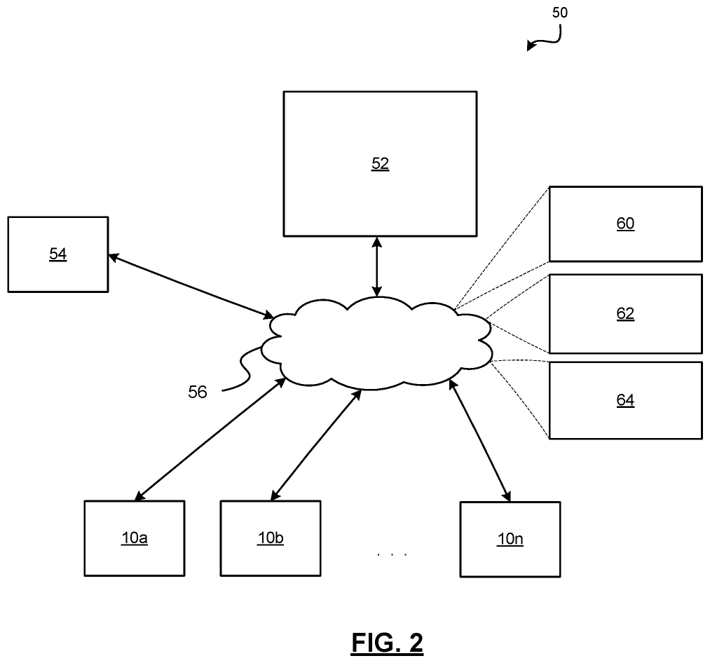

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10. In one embodiment, as discussed in detail below, the controller 34 is configured to predict the behavior of objects in the vicinity of AV 10 and control the AV 10 based thereon.

The communication system 36 is configured to wirelessly communicate information to and from other objects 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system (or simply “remote transportation system”) 52 that is associated with one or more autonomous vehicles 10a-10n as described with regard to FIG. 1. In various embodiments, the operating environment 50 (all or a part of which may correspond to objects 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information. In one embodiment, as described in further detail below, remote transportation system 52 includes a route database 53 that stores information relating to navigational system routes and also may be used to perform traffic pattern prediction.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

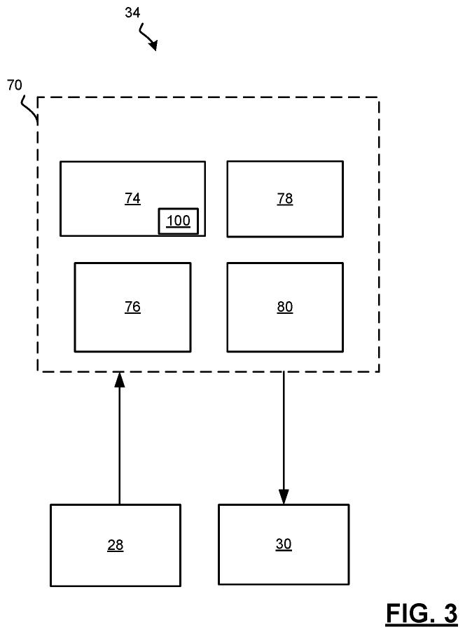

In accordance with various embodiments, the controller 34 implements an autonomous driving system (ADS) 70 as shown in FIG. 3. That is, suitable software and/or hardware components of the controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a computer vision and sensor processing system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision and sensor processing system 74 synthesizes and processes sensor data and predicts the presence, location, classification, and/or path of objects and features of the environment of the vehicle 10. In various embodiments, the computer vision and sensor processing system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, the object behavior prediction system 100 is configured to predict the behavior of objects in the vicinity of AV 10 and iteratively improve those predictions over time based on its observations of those objects. In some embodiments, this functionality is incorporated into computer vision and sensor processing system 74 of FIG. 2.

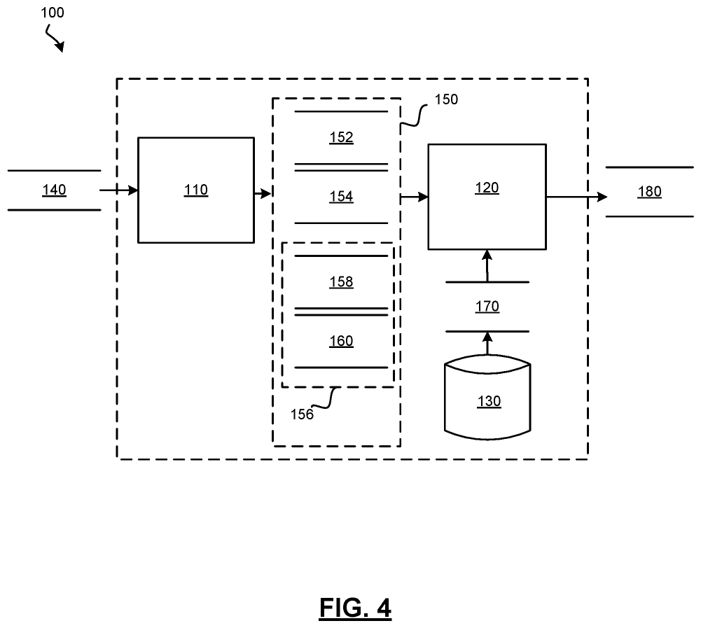

In that regard, FIG. 4 is a dataflow diagram illustrating aspects of the object behavior prediction system 100 in more detail. It will be understood that the sub-modules shown in FIG. 4 can be combined and/or further partitioned to similarly perform the functions described herein. Inputs to modules may be received from the sensor system 28, received from other control modules (not shown) associated with the autonomous vehicle 10, received from the communication system 36, and/or determined/modeled by other sub-modules (not shown) within the controller 34 of FIG. 1.

As shown, the object behavior prediction system 100 may include a feature extraction module 110, a model processing module 120, and a regression model datastore 130. In various embodiments, the modules 110, 120 and datastore 130 may be implemented using any desired combination of hardware and software. In some embodiments, the modules 110, 120 implement a global network comprising a combination of a number of machine learning (ML) models. In various embodiments, as will be discussed in the exemplary embodiments herein one or more of the modules 110, 120 implement one or more tree-based regression models.

As shown in FIG. 4, the feature extraction module 110 receives as input sensor data 140. The sensor data 140 may be generated, for example, by the sensor system 28 of the vehicle 10. The feature extraction module 110 processes the sensor data 140 to first determine objects within a defined vicinity (e.g., a defined radius) of the vehicle 10 and for each object to extract feature data 150 associated with the object.

The feature data 150 includes, for example, current features 152, history features 154, and/or interaction features 156. The current features 152 define properties of the object or the environment associated with the object. In various embodiments, the current features 152 can include, but not limited to, data representing a speed of the object, a heading of the object, a type of the object, and a road type associated with the object.

The history features 154 define historical properties of the object or the environment associated with the object. The history can be captured over a time period (e.g., five or more samples at a defined sample rate such as one second or other sample rate). In various embodiments, the history features 154 include, but are not limited to, data representing a change in speed of the object, a change in heading of the object, and a road type associated with the object over the time period.

The interaction features 156 include features for each of the nearest objects (e.g., 3 or more objects determined to be nearest to the current object being evaluated). The features of each nearest object can include, for example, data representing the current features 158 and history features 160. The current features 158 can include the same features as the current object or can include different features. In various embodiments, the current features 158 can include, but are not limited to, data representing an angle, a distance, a speed, a heading, an object type, and a road type associated with the object. The history features 160 can include the same features as the current object or can include different features. In various embodiments, the history features 160 can include, but are not limited to, data representing an angle, a distance, and a road type of a defined time period (e.g., five or more samples at a defined sample rate such as one second or other sample rate).

As can be appreciated, the objects can be identified and the features extracted based on a variety of image processing, lidar data processing, and/or radar data processing techniques that can include machine learning techniques (not discussed herein), such as, for example, but not limited to, multivariate regression, random forest classifiers, Bayes classifiers (e.g., naive Bayes), principal component analysis (PCA), support vector machines, linear discriminant analysis, clustering algorithms (e.g., KNN, K-means), and/or the like.

The model processing module 120 receives the feature data 150 associated with each object. The model processing module 120 processes the feature data 150 with a defined model 170 to predict a future position 180 of the object.

In various embodiments, the model 170 is predefined and stored in the model datastore 130. In various embodiments, the model 170 can be defined based on the number of features. For example, the models 170 can be defined to process more or less features or more or less sub-features associated with each object.

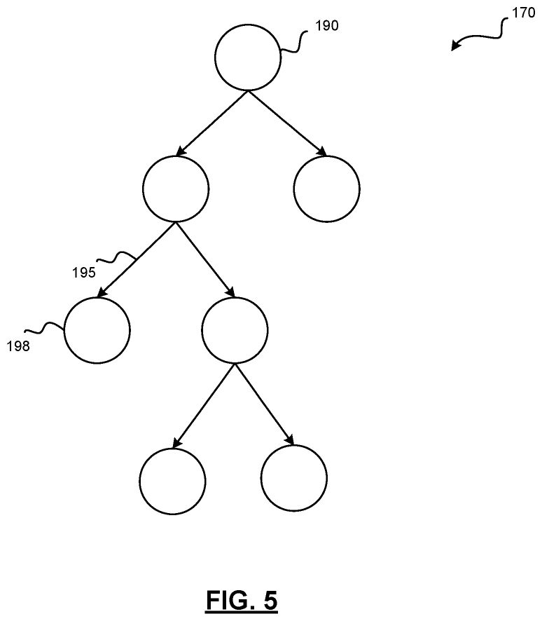

In various embodiments, the models 170 stored in the model datastore 130 are tree-based regression models. For example, as shown in FIG. 5, the tree-based regression model 170 includes a tree model that connects decisions about the various features defined in the feature data 150 (through the branches) to target values (through the nodes). FIG. 5 illustrates a tree model having nodes 190 and branches 195 associated with the feature data 150 as discussed above. As shown in FIG. 5, the regression model 170 is a collection of trees. Each tree has a root node, leaf nodes, and regular nodes. Each non-leaf node (regular node or root node) is associated with a single feature and its threshold value. Each leaf node is associated with a regression value (the output of the tree).

The input to this model is the set of input feature data 150 (e.g., as a feature vector). The model processes the data by starting at the root node and checking the associated feature value with the threshold. The comparison will determine which branch to move to next. Once a leaf is reached, the output value is given. In various embodiments, the size of any one tree is much smaller than the number of features. In such embodiments, multiple trees are used in the model 170. The sum or average from the multiple trees is the output of the model 170.

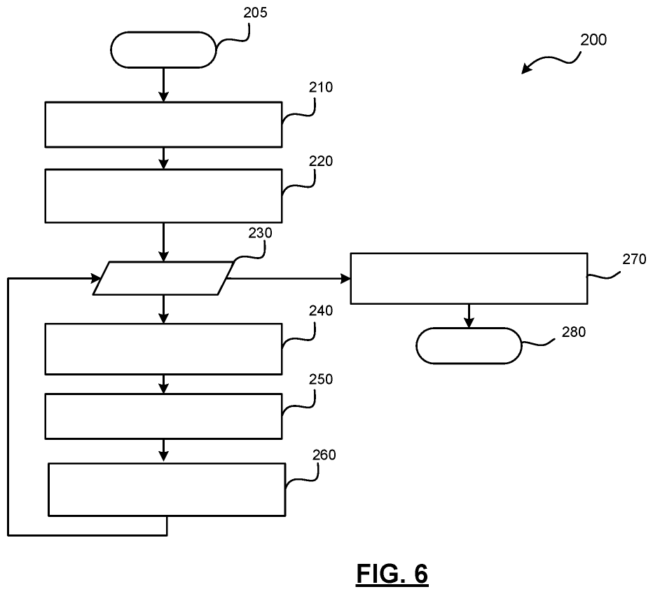

Referring now to FIG. 6, and with continued reference to FIGS. 1-5, a flowchart illustrates a control method 200 that can be performed by the system 100 in accordance with the present disclosure. As can be appreciated in light of the disclosure, the order of operation within the method is not limited to the sequential execution as illustrated in FIG. 6, but may be performed in one or more varying orders as applicable and in accordance with the present disclosure. In various embodiments, the method 200 can be scheduled to run based on one or more predetermined events, and/or can run continuously during operation of the autonomous vehicle 10.

In one example, the method 200 may begin at 205. The sensor data 140 is received at 210. The sensor data 140 is processed with various data processing techniques to determine objects within a vicinity of the vehicle 10 at 220. For each object at 230, the sensor data 140 is further processed to determine the feature data 150 at 240. The regression model 170 associated with the determined feature data 150 is retrieved at 250; and the feature data 150 is processed by the regression model 170 to predict a future position 180 of the object at 260. Once the processing of all objects is complete at 230, the vehicle 10 is controlled based on the predictions of the objects' future positions 180 at 270. Thereafter, the method may end at 280.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle, comprising:
receiving sensor data sensed from an environment associated with the vehicle;
processing, by a processor, the sensor data to determine a plurality of objects within the environment of the vehicle;
processing, by the processor, the sensor data to determine feature data associated with each of the plurality of objects, wherein the feature data includes current data of each object, history data of each object, and interaction data between each object and at least two other objects;
processing, by the processor, the feature data associated with a first object of the plurality of objects with a model to determine a future position of the first object; and
controlling, by the processor, the vehicle based on the future position.

2. The method of claim 1, wherein the current data includes speed data, heading data, object type data, and road type data.

3. The method of claim 1, wherein the history data includes a change in speed data, a change in heading data, and road type data.

4. The method of claim 1, wherein the interaction data includes current data of each object of the at least two other objects, and history data of each object of the at least two other objects.

5. The method of claim 4, wherein the current data of the interaction data includes angle data, distance data, heading data, object type data, and road type data.

6. The method of claim 4, wherein the history data of the interaction data includes angle data, distance data, and road type data.

7. The method of claim 1, wherein the model is a regression model.

8. The method of claim 7, wherein the regression model is a tree-based regression model.

9. The method of claim 1, wherein the model is selected from a plurality of models based on a number of features included in the feature data.

10. A system for controlling a vehicle, comprising:
a data storage device that stores at least one model; and
a processor configured to receive sensor data sensed from an environment associated with the vehicle, process the sensor data to determine a plurality of objects within the environment of the vehicle, process the sensor data to determine feature data associated with each of the plurality of objects, wherein the feature data includes current data of each object, history data of each object, and interaction data between each object and at least two other objects, process the feature data associated with a first object of the plurality of objects with a model to determine a future position of the first object, and control the vehicle based on the future position.

11. The system of claim 10, wherein the current data includes speed data, heading data, object type data, and road type data.

12. The system of claim 10, wherein the history data includes a change in speed data, a change in heading data, and road type data.

13. The system of claim 10, wherein the interaction data includes current data of each object of the at least two other objects, and history data of each object of the at least two other objects.

14. The system of claim 13, wherein the current data includes angle data, distance data, heading data, object type data, and road type data.

15. The system of claim 13, wherein the history data includes angle data, distance data, and road type data.

16. The system of claim 10, wherein the model is a regression model.

17. The system of claim 16, wherein the regression model is a tree-based regression model.

18. The system of claim 16, wherein the processor is further configured to select the model from a plurality of models based on a number of features included in the feature data.

19. An autonomous vehicle comprising:
a sensor system configured to observe an environment associated with the autonomous vehicle; and
a control module configured to, by a processor, receive sensor data sensed from the environment associated with the autonomous vehicle, process the sensor data to determine a plurality of objects within the environment of the autonomous vehicle, process the sensor data to determine feature data associated with each of the plurality of objects, process the feature data associated with a first object of the plurality of objects with a model to determine a future position of the first object, and control the autonomous vehicle based on the future position, and
wherein the feature data includes current data of each object, history data of each object, and interaction data between each object and at least two other objects,
wherein the current data includes speed data, heading data, object type data, and road type data,
wherein the history data includes a change in speed data, a change in heading data, and road type data, and
wherein the interaction data includes current data of each object of the at least two other objects, and history data of each object of the at least two other objects.

19. The autonomous vehicle of claim 18, wherein the current data of the interaction data includes angle data, distance data, heading data, object type data, and road type data.

20. The autonomous vehicle of claim 18, wherein the history data of the interaction data includes angle data, distance data, and road type data.
